(19) United States
(12) Patent Application Publication
(10) Pub. No.: US 2005/0185112 A1
(43) Pub. Date: Aug. 25, 2005

(54) Back light and liquid crystal display unit using this

(75) Inventor: Kazutaka Hara, Ibaraki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 10/507,481

(22) PCT Filed: Mar. 13, 2003
(86) PCT No.: PCT/JP03/02985

(30) Foreign Application Priority Data
Mar. 14, 2002 (JP) 2002-69594

(51) Int. Cl. G02F 1/1335

(52) U.S. Cl. 349/61

(57) ABSTRACT

A backlight used for a liquid crystal display device is characterized by including a bandpass filter that selectively allows blue light having a center wavelength of 400-440 nm, green light having a center wavelength of 520-530 nm and red light having a center wavelength of 620-640 nm, respectively, to pass therethrough, and a light source that emits at least light of the wavelength ranges towards the bandpass filter.

### FIELD OF THE INVENTION

The present invention relates to a backlight used for a liquid crystal display device and more particularly to a backlight that is capable of improving color reproducibility of the liquid crystal display device.

### BACKGROUND OF THE INVENTION

Hitherto, various improvements have been made to a backlight and a color filter of a liquid crystal display device in order to improve color reproducibility of the liquid crystal display device. In most of those improvements, attempts were to widen the color reproduction range by controlling the emission spectrum of the backlight, the transmission spectrum characteristics of the backlight or the like in various ways.

However, it was difficult to improve the color reproducibility (widen the color reproduction range) to the same level as a CRT by the combination of a conventional backlight and a color filter.

More specifically, for many three-band cold cathode lamps used as a light source for the backlight, the center wavelengths of the emission spectrum are 435 nm for blue light, 545 nm for green light and 610 nm for red light. It is preferable to shift them to about 530 nm for green light and 630 nm for red light for improved color reproducibility. However, it was technically difficult to shift the wavelengths of the emission spectrum (bright-line spectrum) of rare-earth elements used as fluorescent materials for the cold cathode lamps.

Also, by broadening the emission spectrum of a cold cathode lamp, it is possible to relatively increase the amount of luminous energy of the aforementioned wavelength ranges (about 530 nm for green light and 630 nm for red light); however, there arises a problem that the broadened emission spectrum increases color mixing due to poor color separation of a color filter (the transmission spectrum band of the color filter represents broad characteristics).

In order to prevent the color mixing, it is desirable to form certain band gaps in the emission spectrum between blue light and green light, and between green light and red light; however, it was difficult to prepare such an ideal light source. Also, it is difficult to form a band gap by a color filter that uses the principle of light absorption by pigments, dies or the like.

### SUMMARY OF THE INVENTION

The present invention has been conceived in order to solve the above problems associated with the prior arts. It is an object of the present invention to provide a backlight that is capable of improving the color reproducibility of a liquid crystal display device.

In order to achieve the above object, according to the present invention, there is provided a backlight, which includes a bandpass filter that selectively allows blue light having a center wavelength of 400-440 nm, green light having a center wavelength of 520-530 nm and red light having a center wavelength of 620-640 nm, respectively, to pass therethrough, and a light source that emits at least light of the aforesaid wavelength ranges towards the bandpass filter.

According to the present invention, since the bandpass filter that selectively allows blue light having a center wavelength of 400-440 nm, green light having a center wavelength of 520-530 nm and red light having a center wavelength of 620-640 nm, respectively, to pass therethrough is used, it is possible to allow light emitted from the light source to pass through the bandpass filter, while allowing green light and red light to respectively have the center wavelengths shifted to 520-530 nm and 620-640 nm, as well as forming certain band gaps in the spectrum of transmitted light between blue light and green light and between green light and red light. Thus, it is possible to prevent color mixing, while improving the color reproducibility. As the light source, those of various types having a broad spectrum characteristic may be applied, as long as they have the emission spectrum containing at least the passband of the bandpass filter.

The bandpass filter that allows light of the aforesaid wavelength range to pass therethrough may have a varying form by applying a conventional film design technique. As generally known, the wavelength-selectivity of the bandpass filter can be designed to offer sharp cutoff characteristics as compared with a color filter that uses the principle of light absorption by pigments, dies or the like. Also, in comparison with the case where the emission spectrum of rare-earth elements are to be set, the bandpass filter achieves ease of setting of wavelengths, ease of designing or the like, thus contributing to enhanced flexibility. Since the bandpass filter is a filter that essentially absorbs no light, heat resulting from light absorption is not transmitted to a liquid crystal cell via the bandpass filter even with an increased brightness of the light source, and hence is advantageously blocked by the bandpass filter.

Preferably, a prism sheet or directional optical transmission member that has a prism structure capable of increasing the component of light perpendicularly incident from the light source on the bandpass filter is disposed between the light source and the bandpass filter.

It is generally known that the wavelength of light transmitted through the bandpass filter is shifted depending on the angle of incident of light on the bandpass filter and therefore the spectrum of the transmitted light is changed. According to the present invention, since there is provided the prism sheet or directional optical transmission member that has a prism structure capable of increasing the component of light perpendicularly incident from the light source on the bandpass filter, light that has passed through the prism sheet or directional optical transmission member is easy to be perpendicularly incident on the bandpass filter. Therefore, it is possible to limit change of the spectrum and hence reduce change of color tone according to the viewing angle of a liquid crystal display device which uses the backlight of the present invention. By the directional optical transmission member is meant herein an optical transmission member that forms or build up on the surface of the emission side thereof a prism structure capable of increasing the component of perpendicularly incident light.

The bandpass filter may be formed by using such as cholesteric liquid crystal.

More specifically, the bandpass filter may be formed by laminating together cholesteric liquid crystal layers, which respectively allow blue light having a center wavelength of 400-440 nm, green light having a center wavelength of 520-530 nm and red light having a center wavelength of 620-640 nm to pass therethrough, and a reflection polarizer disposed close to the light source, so as to be capable of allowing light of a specific wavelength to pass through the bandpass filter while light of the other wavelengths to be reflected thereon.

The bandpass filter may be formed by having a half wavelength plate held between cholesteric liquid crystal layers that respectively reflect circularly polarized light of the same circular polarization as each other. This filter is also possible to allow light of a specific wavelength to pass therethrough while allowing light of the other wavelengths to be reflected thereon.

Herein, the half wavelength plate may be a broadband half wavelength plate that corresponds to the visible light range, thereby allowing itself to serve as a half wavelength plate for light of all the visible light range emitted from the light source, and therefore the bandpass filter to have an enhanced precision.

The bandpass filter may be formed by laminating together cholesteric liquid crystal layers that respectively reflect circularly polarized light of the opposite circular polarizations.

Preferably, of the cholesteric liquid crystal layers, it is so formed that one cholesteric liquid crystal layer disposed close to the light source reflects circularly polarized light of a wide wavelength range corresponding to the visible light range, while another allowing blue light having a center wavelength of 400-440 nm, green light having a center wavelength of 520-530 nm and red light having a center wavelength of 620-640 nm to pass therethrough.

According to the present invention, light that has passed through the bandpass filter turns into circularly polarized light. Therefore, by changing circularly polarized light into linearly polarized light by for example a quarter wavelength plate (for matching its plane of polarization to a plane of polarization of a polarizing plate mounted on the light-source side of the liquid crystal cell of the liquid crystal display device), it is possible to cause no absorption loss and efficiently utilize light emitted from the light source. Circularly polarized light reflected on the one cholesteric liquid crystal layer has its circular polarization reversed when it is further reflected on the light source (the optical transmission member), and then turns into circularly polarized light capable of passing through the bandpass filter. Thus, it is possible to re-utilize the reflected light and hence produce a backlight that realizes high utilization efficiency of light.

Herein, the bandpass filter may comprise a multilayer lamination of resin films respectively having different refractive indexes.

The multilayer lamination of the resin films may be formed through film deposition, or through multilayer extrusion and then stretching. Alternatively, the multilayer lamination of the resin films may be formed through multilayer extrusion and then biaxial stretching. In addition, the resin films may have birefringence anisotropy by being subjected to stretching and orientation, and the multilayer lamination of the resin films may be formed through multilayer extrusion and then biaxial stretching.

Alternatively, the bandpass filter may comprise a multilayer lamination of dielectric films respectively having different refractive indexes.

According to the present invention, there is also provided a liquid crystal display device that includes a liquid crystal cell and a backlight that illuminates the liquid crystal cell.

Preferably, the liquid crystal display device includes a diffusing plate disposed between the backlight and the liquid crystal cell. When the component of light perpendicularly incident on the bandpass filter is excessively increased, the component of light perpendicularly incident on the liquid crystal cell is also excessively increased and hence there arises a problem that the viewing angle within which a displayed content of the liquid crystal display device can be visually recognized is narrowed. Light of a specific wavelength is transmitted by the bandpass filter and then the transmitted light is diffused by the diffusing plate, thereby illuminating the liquid crystal cell. This makes it possible to provide a liquid crystal display device that has both a good viewing angle characteristic and a good wavelength distribution characteristic.

### BRIEF DESCRIPTION OF THE DRAWINGS

FIG. 1 is a longitudinal cross sectional view illustrating a schematic arrangement of a liquid crystal display device equipped with a bandpass filter according to an embodiment of the present invention.

FIG. 2 is a longitudinal cross sectional view illustrating a schematic arrangement of a liquid crystal display device equipped with a bandpass filter according to another embodiment of the present invention.

FIG. 3 illustrates the transmission spectral characteristic of the bandpass filter according to Example 1 of the present invention.

FIG. 4 is an xy chromaticity diagram of a liquid crystal display device using the bandpass filter of Example 1 of the present invention.

FIG. 5 illustrates the transmission spectral characteristic of the bandpass filter according to Example 2 of the present invention.

FIG. 6 is an explanatory view illustrating an example of the laminated arrangement of a linearly-polarized-light reflection polarizer, a half wavelength plate and a quarter wavelength plate, according to Example 8 of the present invention.

FIG. 7 is an xy chromaticity diagram of a conventional liquid crystal display device.

### BEST MODE FOR CARRYING OUT THE INVENTION

Now, the description will be made for an embodiment of the present invention with reference to the drawings attached hereto.

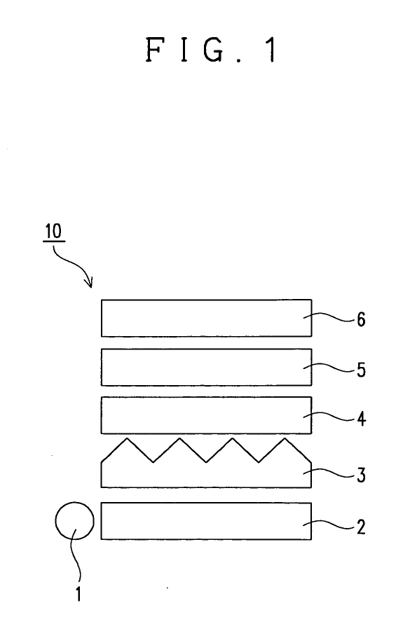

FIG. 1 is a longitudinal cross sectional view illustrating a schematic arrangement of a liquid crystal display device equipped with a bandpass filter according to an embodiment of the present invention. As illustrated in FIG. 1, a liquid crystal display device 10 of this embodiment includes a light source 1 as a backlight, a bandpass filter 4 for allowing light emitted from the light source 1 to pass therethrough, and a liquid crystal cell (including a color filter, a polarizing plate and the like) 6 that is illuminated by light emitted from the bandpass filter 4. The liquid crystal display device 10 further includes an optical transmission member 2, a prism sheet 3 and a diffusing plate 5.

As the light source 1, in addition to a cold cathode lamp, combined LEDs (Light Emitting Diodes), an incandescent lamp or the like may be used. Since it is generally difficult to modify or adjust the wavelength of the light source and, as described later, light of only a specific wavelength is to be transmitted by the bandpass filter 4, it is preferable to use as the light source 1 a light source that has a broad spectrum characteristic that contains the passband of the bandpass filter 4.

The optical transmission member 2 is to transmit light emitted from the light source 1 to the prism sheet 3, and may be formed by using a transparent resin having a light transmitting characteristic, such as acrylic resin, polycarbonate resin, norbornene resin or the like.

The prism sheet 3 is provided to increase the component of light perpendicularly incident on the bandpass filter 4. Depending on the intended use, one or two prism sheets are used. The prism sheet 3 has minute prisms arrayed on its one side at a certain pitch, in which the apex angle of the minute prisms is determined so as to have a light condensing degree (component of perpendicularly incident light) corresponding to the passband of the bandpass filter 4.

The diffusing plate 5 is provided in order to obtain a good viewing angle characteristic by illuminating the liquid crystal cell 6 upon dispersing light transmitted through the bandpass filter 4. The diffusing plate 5 may be formed by embossing the surface of a flat film or depositing particles thereon by using a resin, thus forming uneven surface configuration on a flat film, or embedding particles respectively having different refractive indexes in a resin film.

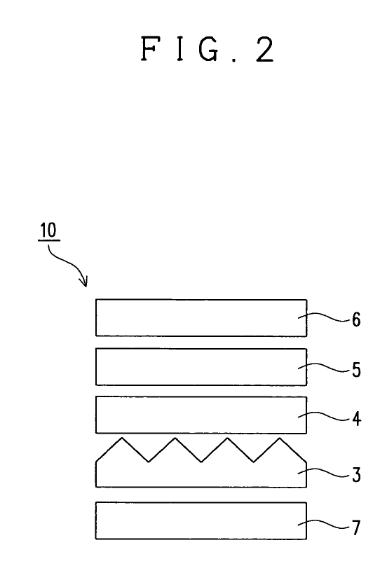

As the light source, it is possible to use a surface-emitting source 7 that allows light to directly enter the bandpass filter 4 (the prism sheet 3 in this embodiment) without intervention of the optical transmission member 2, as illustrated in FIG. 2. As the surface-emitting source 7, it is possible to use such as a flat fluorescent lamp or an electro luminescence film.

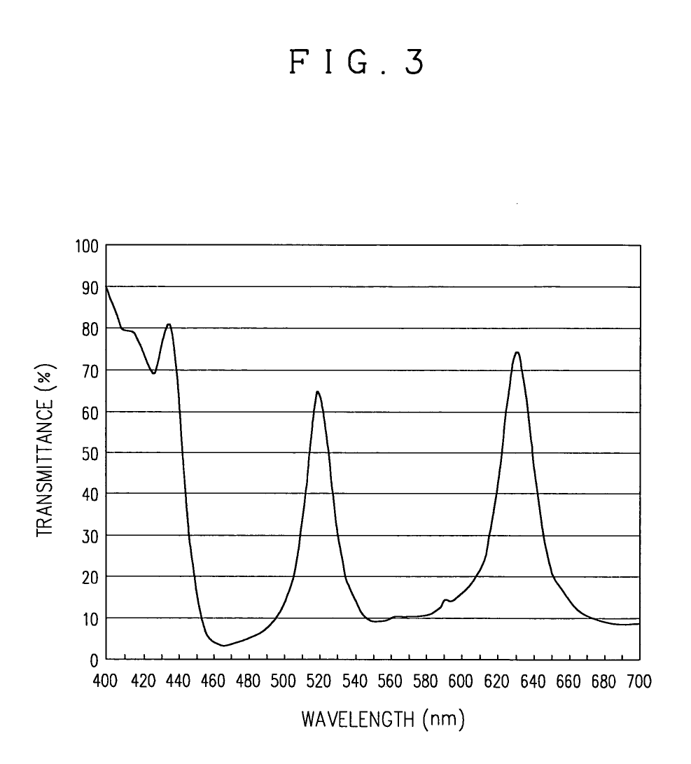

The bandpass filter 4 is so formed as to have a characteristic that allows blue light having a center wavelength of 400-440 nm, green light having a center wavelength of 520-530 nm, and red light having a center wavelength of 620-640 nm, respectively, to pass therethrough. FIG. 3 illustrates an example of the transmission spectral characteristics of the bandpass filter, which comprises a multilayer lamination of dielectric films respectively having different refractive indexes formed through vapor deposition on a transparent substrate. The bandpass filter exhibiting the transmission spectral characteristic as illustrated in FIG. 3 is formed so as to have center wavelengths of the passbands set respectively at 435 nm for blue light, 520 nm for green light and 630 nm for red light. Although the bandpass filter comprising the multilayer lamination of the dielectric films, which exhibits the transmission spectral characteristic as illustrated in FIG. 3, is formed through vapor deposition, this is not essential. A bandpass filter, which comprises the multilayer lamination of resin films or cholesteric liquid crystal, can also exhibit the same characteristic as illustrated in FIG. 3.

Now, the description will be made for an example of the bandpass filter applicable in this embodiment.

(1) In Case of Using Dielectric Materials or the Like

As a high refractive index material, a metal oxide such as TiO₂, ZrO₂ or ZnS or a dielectric material is used, while as a low refractive index material, a metal oxide such as SiO₂, MgF₂, Na₃AlF₆ or CaF₂ or a dielectric material is used. A multilayer lamination of these materials respectively having different refractive indexes are formed through vapor deposition on a transparent substrate. Thus, the bandpass filter 4 is prepared.

(2) In Case of Using Cholesteric Liquid Crystal

The bandpass filter may be formed by having a half wavelength plate held between cholesteric liquid crystal layers that respectively reflect circularly polarized light of the same circular polarization as each other, or by laminating together cholesteric liquid crystal layers respectively reflecting circularly polarized light of the opposite circular polarizations and then depositing them on a transparent substrate. Where the bandpass filter 4 is formed by using cholesteric liquid crystal, it is necessary to use as the transparent substrate a substrate which causes a small phase difference (not more than 20 nm and preferably not more than 10 nm). The half wavelength plate may be formed by stretching a resin having birefringence anisotropy, such as polycarbonate, or by film deposition of liquid crystal polymer.

(3) In Case of Using a Resin

For example, a halogenated resin composition represented by polyethylene naphthalate, polyethylene terephthalate, polycarbonate, vinyl carbazole and brominated acrylate, a high refractive index resin material such as a resin composition with ultrafine particles of a high refractive index inorganic material embedded therein, a fluorocarbon resin material represented by such as trifluoroethyl acrylate, and a low refractive index resin material such as an acrylic resin represented by polymethyl methacrylate may be used, in which these materials having such different refractive indexes are laminated on the transparent substrate. Thus, the bandpass filter 4 can be produced. A multilayer lamination of a resin film may be formed through film deposition (precise deposition), as well as through stretching a multilayer sheet produced by multilayer extrusion.

While the material of the transparent substrate used in the above (1)-(3) is not limited to a specific one, a polymer, a glass material or the like is generally used. As examples of the polymer, it can be cited a cellulosic polymer such as cellulose diacetate and cellulose triacetate, polyester polymer such as polyethylene terephthalate and polyethylene naphthalate, polymer such as polyolefin polymer and polycarbonate polymer, and the like.

Where a so-called reflection polarizer (which reflects light having a plane of polarization perpendicular to a plane of polarization of a polarizer located close to the light source of the liquid crystal cell 6) is located between the bandpass filter 4 and the prism sheet 3 so as to increase the quantity of light passing through the bandpass filter 4, it is preferable to use, as the transparent substrate, a film of cellulose triacetate, nonoriented polycarbonate, nonoriented polyethylene terephthalate or norbornene resin, each causing a small phase difference.

### EXAMPLES

Examples and Comparative Examples as presented will make the characteristics of the present invention more clear.

### Example 1

Fifteen layers of films of TiO₂/SiO₂ were laminated together through thin film deposition so as to prepare a bandpass filter that has passbands respectively having center wavelengths of 435 nm, 520 nm and 630 nm. As a transparent film substrate, which serves as a base for vapor deposition, LUMIRROR manufactured by Toray Industries, Inc. (thickness: 75 μm) was used. The transmission spectral characteristic of the bandpass filter thus prepared is illustrated in FIG. 3. As illustrated in FIG. 3, the peak wavelengths of the passbands of the prepared bandpass filter were respectively about 437 nm, 525 nm and 628 nm, and therefore it was found that only light of specific wavelengths is selectively transmitted as substantially intended in design.

As the light source for the backlight, color cold cathode lamps manufactured by ELEVAM Corporation (one for each of three types, namely, R=OF type, G=BC type and B=GP type) were used. As the prism sheet, the one which has two BEF sheets manufactured by 3M Co., Ltd. overlapped with their axes crossing each other was used. As the diffusing plate, a diffusing plate manufactured by KIMOTO Co., Ltd. was used. These were laminated on the optical transmission plate and a backlight body that is capable of changing the luminous intensities of RGB colors independently of each other was prepared. Accordingly, light emitted from the backlight body is concentrated within an angular range of ±40 degrees relative to the front and the luminous intensity of each color can be adjusted. As a result, white color can easily be produced.

With the arrangement having the bandpass filter located on the backlight body, the characteristic of light selectively allowed through the bandpass filter towards the front can be obtained. Herein, Since the transmittances of the colors of the bandpass filter are not matched to each other, the outputs of the cold cathode lamps were adjusted so as to have the color of light transmitted through the bandpass filter towards the front turned into white.

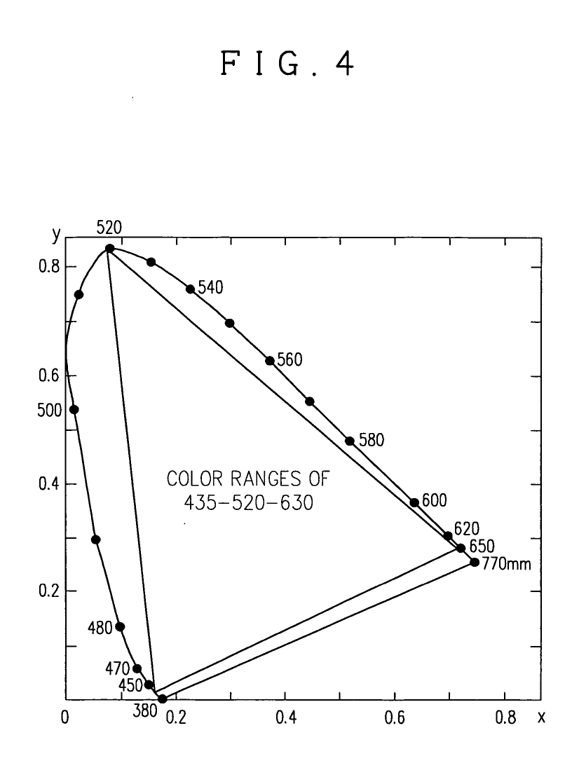

The color reproduction range of the liquid crystal display device using the thus prepared backlight turns into the one as illustrated in the xy chromaticity diagram of FIG. 4; and it was found that a display having a wider color reproduction range than ever before can be produced.

### Example 2

A multilayer lamination of twenty-one layers of fluorinated acrylate resin (LR202B manufactured by Nissan Chemical Industries, Ltd.) and acrylate resin with ultrafine particles of a high refractive index inorganic material embedded therein (DeSolite manufactured by JSR Corporation) was formed by multilayer film deposition so as to prepare a bandpass filter that has passbands respectively having center wavelengths of 435 nm, 520 nm and 630 nm. As a substrate film, TAC film, TD-TAC 80 μm manufactured by Fuji Photo Film Co., Ltd. was used.

Herein, the refractive index of fluorinated acrylate resin was about 1.40, while the refractive index of the acrylate resin with ultrafine particles of a high refractive index inorganic material embedded therein was about 1.71. The multilayer film deposition was conducted by using a micro gravure coater by repeating the steps of drying each laminated film at 90° C. for one minute, curing it by ultraviolet polymerization (luminance: 50 mW/cm²×1 sec), and coating another film on the cured film. The thus prepared bandpass filter exhibited insufficient homogeneity in in-plane transmission spectrum characteristics and therefore a region thereof, which had proper characteristics for an applicable wavelength range, was selected for use.

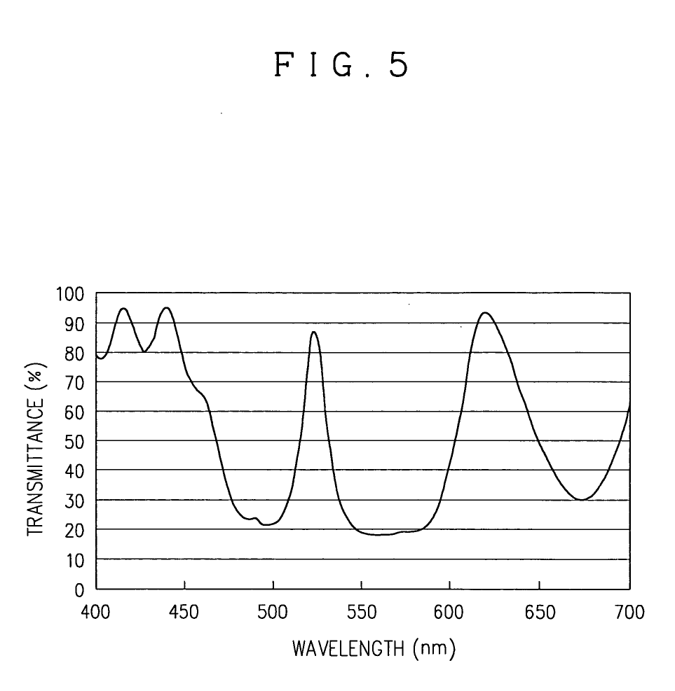

The transmission spectrum characteristic of the thus prepared bandpass filter is illustrated in FIG. 5. As illustrated in FIG. 5, it was found that only light of a specific wavelength is selectively transmitted as substantially intended in design. The backlight with this bandpass filter mounted on the backlight body in the same manner as in Example 1 has peak wavelengths in the emission spectrum respectively at 435 nm, 520 nm and 630 nm, so that only the range with long emission wavelength of red can be taken out and the color reproduction range can be widened, as well as the color purity of each color can be improved. As a result, the color reproducibility of neutral color was improved. These effects are necessarily determined solely by the center wavelengths of the passbands and therefore were the same as those of Example 1.

### Example 3

A multilayer lamination of cholesteric liquid crystal adapted to three wavelengths, which reflect right circularly polarized light, was formed so as to prepare two multilayer cholesteric liquid crystal members (hereinafter referred to a right-circularly-polarized-light reflection plate). A half wavelength plate was held between these two multilayer members so as to prepare a bandpass filter.

In the above description, cholesteric liquid crystal as used comprises the mixture of a polymeric mesogenic compound and a polymeric chiral agent. As the polymeric mesogenic compound, LC242 manufactured by BASF AG was used, and as the polymeric chiral agent, LC756 manufactured by BASF AG was used. The mixing ratio of them was properly set so as to prepare three types of cholesteric liquid crystal whose center values of selective reflections are respectively 470 nm, 570 nm and 690 nm. That is, cholesteric liquid crystal whose center value of selective reflection being 470 nm was prepared by setting the mixing ratio of the polymeric mesogenic compound to the polymeric chiral agent (hereinafter referred to “methogen/chiral”) at 5.7/94.3. Similarly, cholesteric liquid crystal whose center wavelength of selective reflection being 570 nm was prepared by setting the methogen/chiral at 4.8/95.2, and cholesteric liquid crystal whose center wavelength of selective reflection being 690 nm was prepared by setting the methogen/chiral at 4/96.

Specifically, the polymeric chiral agent and the polymeric mesogenic compound were dissolved in cyclopentane (20 wt. %), and a reaction initiator (Irg907 manufactured by Chiba Geigy Co., Ltd., 1 wt. %) was added thereto. As an oriented substrate, Lumirror 75 μm, a PET film manufactured by Toray Industries, Inc. was used and orientation treatment was subjected thereto by rubbing cloth. The solution was then coated on the oriented substrate with a wire bar to have a thickness of 2 μm, dried at 90° C. for two minutes, and then cured by irradiation with ultraviolet rays (10 mW/cm²×1 minute) under 80° C. The oriented substrate was then peeled away from the cured liquid crystal layer, and films produced thereby were laminated in three layers by using a tackiness agent No. 7 manufactured by Nitto Denko Corporation (acrylic agent, thickness of 25 μm).

A half wavelength plate of polycarbonate (NRF-270 nm manufactured by Nitto Denko Corporation) was held between the thus prepare two right-circularly-polarized-light reflection plates and bonded together by a tackiness agent (Tackiness Agent No. 7 manufactured by Nitto Denko Corporation, thickness of 25 μm). Thus, the bandpass filter was prepared.

The bandpass filter thus prepared and mounted on the backlight body in the same manner as in Example 1 had peak wavelengths in the emission spectrum respectively at 435 nm, 520 nm and 630 nm, so that only the range with long emission wavelength of red can be taken out and the color reproduction range can be widened, as well as the color purity of each color can be improved. As a result, the color reproducibility of neutral color could be improved. These effects are necessarily determined solely by the center wavelengths of the passbands and therefore were the same as those of Example 1.

### Example 4

Two right-circularly-polarized-light reflection plates were prepared and a half wavelength plate was held therebetween so as to prepare a bandpass filter. The right-circularly-polarized-light reflection plates used herein were the same as those of Example 3.

For preparation of the half wavelength plate, LC242 manufactured by BASF AG was used as the polymeric mesogenic compound, to which a light sensitive initiator (Irg907 manufactured by Chiba Geigy Co.,Ltd., 1 wt. %) was added so as to prepare an MEK solution (20 wt. %). The solution was coated on an oriented substrate (prepared by subjecting Lumirror 75 μm, a PET film manufactured by Toray Industries, Inc. to orientation treatment with rubbing cloth) with a wire bar coater to have a thickness of about 2.5 μm when dried, and dried at 90° C. for two minutes, and then cured by irradiation with ultraviolet rays (10 mW/cm2×1 minute). The oriented substrate was then peeled away from the cured liquid crystal layer. Thus, the half wavelength plate was prepared.

The thus prepared half wavelength plate was held between the two right-circularly-polarized-light reflection plates and bonded together with isocyanate adhesive (coated with a thickness of 2 μm). Thus, the bandpass filter was prepared.

While the thus prepared bandpass filter is about 90 μm thinner than the bandpass filter of Example 3 in the entire thickness, it had equivalent optical characteristics. The effects such as the color reproducibility are necessarily determined solely by the center wavelengths of the passbands and therefore were the same as those of Example 1.

### Example 5

A multilayer lamination of cholesteric liquid crystal (a right-circularly-polarized-light reflection plate) adapted to three wavelengths, which reflects right circularly polarized light, was prepared in the same manner as in Example 3. A bandpass filter was prepared by laminating NIPOCS (PCF400) manufactured by Nitto Denko Corporation, which reflects left circularly polarized light. For laminating them together, an acrylic tackiness agent (Tackiness Agent No. 7 manufactured by Nitto Denko Corporation, thickness: 25 μm) was used.

The optical characteristics of the thus prepared bandpass filter were equivalent to those of the bandpass filter of Example 3. The effects such as the color reproducibility are necessarily determined solely by the center wavelengths of the passbands and therefore were the same as those of Example 1.

The bandpass filter of this Example was disposed so that the backlight body, the bandpass filter (disposed with the NIPOCS facing towards the backlight body and the right-circularly-polarized-light reflection plate facing towards the liquid crystal cell), the phase difference plate (NRF film, a quarter wavelength plate manufactured by Nitto Denko Corporation, phase difference value: 140 nm), a polarizing plate and the liquid crystal cell are aligned in this order. With this arrangement, the brightness was improved about 1.5 times compared to Examples 1-4.

This is because light transmitted through the bandpass filters of Examples 1-4 is not polarized light and therefore half of the transmitted light is lost by absorption at the polarizing plate mounted close to the light source of the liquid crystal cell. More specifically, in Examples 1 and 2, the bandpass filter is an interference filter and therefore does not cause a phase difference so that transmitted light does not turn into polarized light. Also, in Examples 3 and 4, a reflection-type polarizing plate of cholesteric liquid crystal is utilized; however it does not function as a circularly polarizing plate in the wavelength range of transmitted light, therefore natural light passes therethrough, and hence the transmitted light is unlikely to be polarized. On the contrary, in this Example, the NIPOCS manufactured by Nitto Denko Corporation, which functions as a circularly-polarized-light reflection plate in the entire wavelength range of the visible light is used on the light-source side. Therefore, light transmitted through the NIPOCS turns into circularly polarized light so that light reflected on the NIPOCS has circular polarization reversed at the time of further reflection on the backlight body and the light reflected is thus utilized.

### Example 6

A multilayer lamination of cholesteric liquid crystal (a right-circularly-polarized-light reflection plate) adapted to three wavelengths, which reflects right circularly polarized light, was prepared in the same manner as in Example 3. As a left-circularly-polarized-light reflection plate that reflects left circularly polarized light, a lamination made up of NRF film (phase difference value: 140 nm) manufactured by Nitto Denko Corporation and DBEF manufactured by 3M Co., Ltd. was used. A bandpass filter was prepared by laminating them together. For laminating them together, an acrylic tackiness agent (Tackiness Agent No. 7 manufactured by Nitto Denko Corporation, thickness: 25 μm) was used.

Circularly polarized light is produced by laminating a linear polarizer to a quarter wavelength plate with their axes inclined 45 degrees to each other. Therefore, in this Example, it was determined that the quarter wavelength plate is laminated in a direction 45 degrees inclined to the transmission axis of DBEF manufactured by 3M Co., Ltd. (a linearly-polarized-light reflection polarizer that reflects linearly polarized light). Herein, the wavelength representative of the maximum sensitivity to visible light is about 550 nm and therefore a phase difference value of about 140 nm corresponds to a quarter wavelength (Accordingly, the NRF film having a phase difference value of 140 nm serves as the quarter wavelength plate).

The bandpass filter of this Example was disposed so that the backlight body, the bandpass filter (disposed with the DBEF, the quarter wavelength plate and the right-circularly-polarized-light reflection plate aligned in this order from the backlight body side towards the liquid crystal cell side), the phase difference plate (the quarter wavelength plate), the polarizing plate and the liquid crystal cell are aligned in this order. That is, for replacement of the function of the NIPOCS of Example 5 by the DBEF, a means of turning linearly polarized light into circularly polarized light (the quarter wavelength plate in this Example) is required. On the other hand, since it is necessary to have circularly polarized light returned to linearly polarized light before light is emitted on the polarizing plate mounted on the light-source side of the liquid crystal cell, a quarter wavelength plate is further needed. Because of this, as in the above arrangement, two quarter wavelength plates with the circularly-polarized-light reflection plate held therebetween are needed. The distribution state of condensed light observed in this Example is completely identical to that of Example 3; however the front brightness of the liquid crystal display device comprising the above arrangement has improved 1.5 times as much compared to that of Example 3 since incident light is re-utilized in the same manner as Example 5.

### Example 7

A multilayer lamination of cholesteric liquid crystal (a right-circularly-polarized-light reflection plate) adapted to three wavelengths, which reflects right circularly polarized light, was prepared in the same manner as in Example 3. As a left-circularly-polarized-light reflection plate that reflects left circularly polarized light, a lamination made up of NRZ film (phase difference value: 140 nm, Nz coefficient: 0.5) manufactured by Nitto Denko Corporation and DBEF manufactured by 3M Co., Ltd. was used. A bandpass filter was prepared by laminating them together. For laminating them together, an acrylic tackiness agent (Tackiness Agent No. 7 manufactured by Nitto Denko Corporation, thickness: 25 μm) was used.

Circularly polarized light is produced by laminating a linear polarizer to a quarter wavelength plate with their axes inclined 45 degrees to each other. Therefore, in this Example, it was determined that the quarter wavelength plate is laminated in a direction 45 degrees inclined to the transmission axis of the DBEF manufactured by 3M Co., Ltd. (a linearly-polarized-light reflection polarizer that reflects linearly polarized light). Herein, the wavelength representative of the maximum sensitivity to visible light is about 550 nm and therefore a phase difference value of about 140 nm corresponds to a quarter wavelength (Accordingly, the NRZ film having a phase difference value of 140 nm serves as the quarter wavelength plate).

The bandpass filter of this Example was disposed so that the backlight body, the bandpass filter (disposed with the DBEF, the quarter wavelength plate and the right-circularly-polarized-light reflection plate aligned in this order from the backlight body side towards the liquid crystal cell side), the phase difference plate (the quarter wavelength plate), the polarizing plate and the liquid crystal cell are aligned in this order. That is, for replacement of the function of the NIPOCS of Example 5 by the DBEF, a means of turning linearly polarized light into circularly polarized light (the quarter wavelength plate in this Example) is required. On the other hand, since it is necessary to have circularly polarized light returned to linearly polarized light before light is emitted on the polarizing plate mounted on the light-source side of the liquid crystal cell, a quarter wavelength plate is further needed. Because of this, as in the above arrangement, two quarter wavelength plates with the circularly-polarized-light reflection plate held therebetween are needed.

In general, the phase difference plate causes variation in phase difference value by the change of an optical path length for light obliquely incident thereon. Therefore, with an increased incident angle, there causes a difference in phase difference value from that of light perpendicularly incident thereon, with the result that the phase difference plate may not carry out its effective function. However, in this Example, the NRZ film, which has a phase difference value controlled in the thickness direction, is used, so that it can function as a quarter wavelength plate as required even for light obliquely incident thereon. With the bandpass filter of this Example, the front brightness of the liquid crystal display device comprising the above arrangement has improved about 1.5 times, since incident light is re-utilized in the same manner as Example 5.

### Example 8

A multilayer lamination of cholesteric liquid crystal (a right-circularly-polarized-light reflection plate) adapted to three wavelengths, which reflects right circularly polarized light, was prepared in the same manner as in Example 3. As a left-circularly-polarized-light reflection plate that reflects left circularly polarized light, a lamination made up of NRZ film (phase difference value: 140 nm, Nz coefficient: 0.5, and phase difference value: 270 nm, Nz coefficient: 0.5) manufactured by Nitto Denko Corporation and DBEF manufactured by 3M Co., Ltd. was used. A bandpass filter was prepared by laminating them together. For laminating them together, an acrylic tackiness agent (Tackiness Agent No. 7 manufactured by Nitto Denko Corporation, thickness: 25 μm) was used.

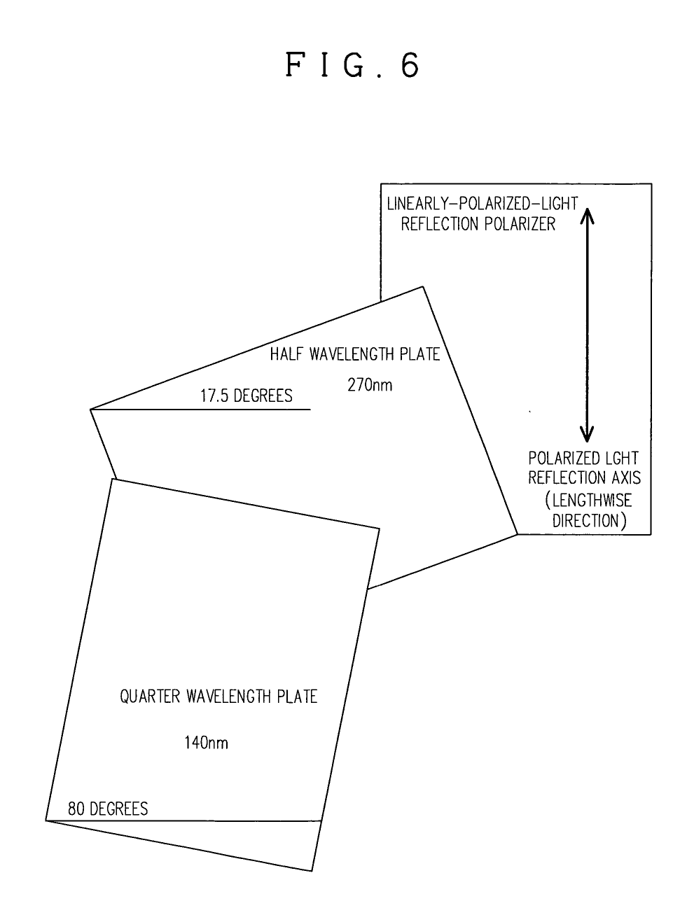

In general, circularly polarized light can be produced by laminating a linear polarizer to a quarter wavelength plate. However, it functions as a quarter wavelength plate only for a specific wavelength, and therefore light other than that of intended wavelengths in design does not turn into circularly polarized light in strict sense and may cause a problem. Accordingly, in this Example, the half wavelength plate and the quarter wavelength plate in combination were laminated with different axes to the DBEF manufactured by 3M Co., Ltd. In this case, the lamination of the half wavelength plate and the quarter wavelength plate functions as a broadband quarter wavelength plate and therefore can produce circularly polarized light throughout the entire visible light range. FIG. 6 illustrates an example of the laminated arrangement of the linearly-polarized-light reflection polarizer, the half wavelength plate and the quarter wavelength plate. The phase difference values and the lamination angles illustrated in FIG. 6 are merely examples and therefore are not limited to these values.

The bandpass filter of this Example was disposed so that the backlight body, the bandpass filter (disposed with the DBEF, the broadband quarter wavelength plate and the right-circularly-polarized-light reflection plate aligned in this order from the backlight body side towards the liquid crystal cell side), the phase difference plate (the broadband quarter wavelength plate), the polarizing plate and the liquid crystal cell are aligned in this order. That is, for replacement of the function of the NIPOCS of Example 5 by the DBEF, a means of turning linearly polarized light into circularly polarized light (the broadband quarter wavelength plate in this Example) is required. On the other hand, since it is necessary to have circularly polarized light returned to linearly polarized light before light is emitted on the polarizing plate mounted on the light-source side of the liquid crystal cell, a broadband quarter wavelength plate is further needed. Because of this, as in the above arrangement, two broadband quarter wavelength plates with the circularly-polarized-light reflection plate held therebetween are needed.

In general, the phase difference plate causes variation in phase difference value by the change of an optical path length for light obliquely incident thereon. Therefore, with an increased incident angle, there causes a difference in phase difference value from that of light perpendicularly incident thereon, with the result the phase difference plate may not carry out its effective function. However, in this Example, the NRZ film, which has a phase difference value controlled in the thickness direction, is used, so that it can function as a quarter wavelength plate as required even for light obliquely incident thereon.

As described above, in this Example, two phase difference plates were laminated together, with their axes different from each other, in order to make them broadband compatible and capable of functioning as the quarter wavelength plate throughout the entire visible light range. Therefore, even in visual recognition of the liquid crystal display device at an oblique angle, there is less variation in phase difference value for each wavelength and uniform characteristics can be obtained in visible light range. Thus, it is advantageous that non-uniformity in wavelength resulting in such as coloration is small. With the bandpass filter of this Example, which re-utilizes the incident light in the same manner as Example 5, the front brightness of the liquid crystal display device comprising the above arrangement has improved about 1.5 times.

### Comparative Example

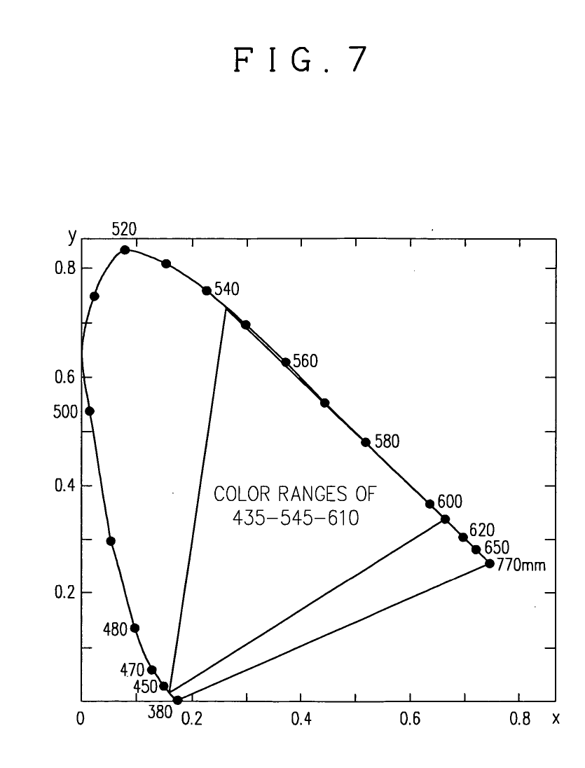

The color reproduction range of a liquid crystal display device using as the backlight a cold cathode lamp (center wavelengths of the emission spectrum: 435 nm, 545 nm and 610 nm) equipped with no bandpass filter appears as illustrated in the xy chromaticity diagram of FIG. 7; and it is found that the liquid crystal display device displays with a narrow color reproduction range.

In the Examples and Comparative Examples as described above, MCPD 2000, Fast Scanning, Multichannel Spectrophotometer manufactured by Otsuka Electronics Co., Ltd. for measurement of a reflection wavelength range; M220, Spectral Ellipsometer manufactured by JASCO Corporation for evaluation of film characteristics; U4100, Spectrophotometer manufactured by Hitachi, Ltd. for evaluation of spectrum characteristics of transmission reflection; DOT3 manufactured by Murakami Color K.K. for evaluation of characteristics of a polarizer; KOBRA21D, Birefringence Analyzer manufactured by Oji Scientific Instruments for measurement of a phase difference value; and Ez Contrast manufactured by ELDIM SA for measurement of viewing angle characteristics (contrast, hue, luminance) were respectively used. For preparation of the bandpass filters and the like, UVC321AM1 manufactured by Ushio Inc. was used.

According to the backlight of the present invention, since a bandpass filter, which selectively allows blue light having a center wavelength of 400-440 nm, green light having a center wavelength of 520-530 nm and red light having a center wavelength of 620-640 nm, respectively, to pass therethrough, is used, it is possible to allow light emitted from the light source to pass through the bandpass filter, with shifting the center wavelength of green light to 520-530 nm and the center wavelength of red light to 620-640 nm, while forming certain band gaps in the spectrum of transmitted light between blue and green and between green and red. Thus, it is possible to prevent color mixing, while improving color reproducibility of a color liquid crystal display device.

1. A backlight used for a liquid crystal display device comprising:
a bandpass filter that selectively allows blue light having a center wavelength of 400-440 nm, green light having a center wavelength of 520-530 nm and red light having a center wavelength of 620-640 nm, respectively, to pass therethrough; and
a light source that emits at least light of the wavelength ranges towards the bandpass filter.

2. The backlight according to claim 1, wherein any one of a prism sheet and a directional optical transmission member, each having a prism structure capable of increasing the component of light perpendicularly incident from the light source on the bandpass filter, is disposed between the light source and the bandpass filter.

3. The backlight according to claim 1, wherein the bandpass filter is formed by using cholesteric liquid crystal.

4. The backlight according to claim 3, wherein the bandpass filter is formed by laminating together cholesteric liquid crystal layers, which respectively allow blue light having a center wavelength of 400-440 nm, green light having a center wavelength of 520-530 nm and red light having a center wavelength of 620-640 nm to pass therethrough, and a reflection polarizer disposed close to the light source.

5. The backlight according to claim 3, wherein the bandpass filter is formed by having a half wavelength plate held between cholesteric liquid crystal layers that respectively reflect circularly polarized light of the same circular polarization as each other.

6. The backlight according to claim 5, wherein the half wavelength plate is a broadband half wavelength plate that corresponds to the visible light range.

7. The backlight according to claim 5, wherein the half wavelength plate is formed by using liquid crystal polymer.

8. The backlight according to claim 3, wherein the bandpass filter is formed by laminating together cholesteric liquid crystal layers that respectively reflecting reflect circularly polarized light of the opposite circular polarizations.

9. The backlight according to claim 5, wherein of the cholesteric liquid crystal layers, one cholesteric liquid crystal layer disposed close to the light source reflects circularly polarized light of a wide wavelength range corresponding to the visible light range, while another cholesteric liquid crystal layer allows blue light having a center wavelength of 400-440 nm, green light having a center wavelength of 520-530 nm and red light having a center wavelength of 620-640 nm to pass therethrough.

10. The backlight according to claim 1, wherein the bandpass filter comprises a multilayer lamination of resin films respectively having different refractive indexes.

11. The backlight according to claim 10, wherein the multilayer lamination of the resin films is formed through film deposition.

12. The backlight according to claim 10, wherein the multilayer lamination of the resin films is formed through multilayer extrusion and then stretching.

13. The backlight according to claim 12, wherein the multilayer lamination of the resin films is formed through multilayer extrusion and then biaxial stretching.

14. The backlight according to claim 12, wherein the resin films have birefringence anisotropy by being subjected to stretching and orientation, and the multilayer lamination of the resin films are formed through multilayer extrusion and then biaxial stretching.

15. The backlight according to claim 1, wherein the bandpass filter comprises a multilayer lamination of dielectric films respectively having different refractive indexes.

16. A liquid crystal display device comprising a liquid crystal cell and the backlight according to claim 1.

17. The liquid crystal display device according to claim 16, further comprising a diffusing plate disposed between the backlight and the liquid crystal cell.
